(19) United States
(12) Patent Application Publication
(10) Pub. No.: US 2025/0334696 A1
(43) Pub. Date: Oct. 30, 2025

(54) VOLUME MEASUREMENT METHOD AND SYSTEM USING LIDAR

(71) Applicant: ISSOFT CO., LTD., Gunpo-si (KR)

(72) Inventors: Hyun Bae SEO, Seongnam-si (KR); Sang Hwa LEE, Siheung-si (KR); Hee Seok SEO, Siheung-si (KR)

(73) Assignee: ISSOFT CO., LTD., Gunpo-si (KR)

(21) Appl. No.: 19/176,937

(22) Filed: Apr. 11, 2025

(30) Foreign Application Priority Data
Apr. 26, 2024 (KR) 10-2024-0055890

(51) Int. Cl. G01S 17/89; G06T 19/20

(52) U.S. Cl. CPC G01S 17/89; G06T 19/20; G06T 2210/56; G06T 2219/2012

(57) ABSTRACT

Disclosed is a volume measurement method and system using LiDAR, including: a plurality of LiDAR sensors configured to acquire data of volume measurement targets; and a volume data integration calculator configured to calculate the volume of the volume measurement targets by integrating the data acquired by the plurality of LiDAR sensors. Therefore, the volume measurement method and system using LiDAR according to the present disclosure can obtain highly accurate volume measurement results in real time by measuring volume on the basis of data acquired from multiple LiDAR sensors, can monitor in real time a storage space for raw materials, which are the volume measurement targets, through control of all operations such as operation control and data acquisition, and can use periodically acquired result data as a foundation for various fields, such as inventory management and asset operation.

### TECHNICAL FIELD

The present disclosure relates to a volume measurement method and system using LiDAR, and more specifically, to a volume measurement method and system that enable accurate volume measurement of raw materials and real-time monitoring through a LiDAR sensor.

### BACKGROUND ART

High-value raw materials are assets of a company, and accurate quantity assessment is an important factor in inventory management and budget planning.

FIG. 1 is a diagram illustrating a method of measuring the volume of raw materials according to the related art.

As shown in FIG. 1, in the related art, raw materials (such as metal raw materials, alloy scrap, and minerals) stored in large warehouses have been inspected by visual inspection (visually determining), and when necessary, their volume has been measured using a laser measuring device for inventory management.

Recently, due to the increase in raw material prices, the importance of accurately identifying and managing raw material inventory has grown even further.

Accordingly, a technology capable of accurately tracking the flow and scale of raw materials and managing them efficiently by measuring their volume in real time is required.

### PRIOR ART DOCUMENT

### Patent Document

Korean Patent No. 10-1932466 (2018. 12. 26)

### DETAILED DESCRIPTION OF INVENTION

### Technical Problems

The present disclosure has been made in an effort to solve the problems described above, and an objective of the volume measurement method and system using LiDAR according to the present disclosure is to obtain highly accurate volume measurement results in real time by measuring volume on the basis of data acquired from multiple LiDAR sensors, and is to provide real-time monitoring of a storage space for raw materials, which are the volume measurement targets, through control of all operations such as operation control and data acquisition.

Further, another objective of the present disclosure is to enable periodically acquired result data to be used as a foundation for various fields, such as inventory management and asset operation.

### Technical Solution

In order to solve the problems described above, a volume measurement system using LiDAR according to an embodiment of the present disclosure includes: a plurality of LiDAR sensors configured to acquire data of volume measurement targets; and a volume data integration calculator configured to calculate the volume of the volume measurement targets by integrating the data acquired by the plurality of LiDAR sensors.

According to another embodiment of the present disclosure, the volume data integration calculator may include: a LiDAR sensor controller configured to control the plurality of LiDAR sensors; and a data acquirer configured to acquire the data measured by the plurality of LiDAR sensors.

According to another embodiment of the present disclosure, the volume data integration calculation may further include a coordinate synchronizer configured to create a three-dimensional point cloud by arranging the respective data measured by the plurality of LiDAR sensors based on a single reference point.

According to another embodiment of the present disclosure, the volume data integration calculator may further include: a noise filter configured to remove noise by optimizing the data of the three-dimensional point cloud; and a target area setter configured to set an area that is an object for calculating the volume of the volume measurement targets in the three-dimensional point cloud.

According to another embodiment of the present disclosure, the volume data integration calculator may further include a volume calculator configured to calculate the volume of the volume measurement targets using the three-dimensional point cloud with the set area

According to another embodiment of the present disclosure, the volume data integration calculator may further include a volume information provider configured to display the calculated volume of the volume measurement targets as a three-dimensional point cloud, with different colors assigned to respective three-dimensional areas.

According to another embodiment of the present disclosure, the volume information provider may display the calculated volume of the volume measurement targets as a three-dimensional point cloud, with different colors according to the height of each three-dimensional area.

According to another embodiment of the present disclosure, the volume information provider may collect the information on the calculated volume of the volume measurement targets, accumulate the information by type of raw material, and calculate and provide variation data and scale data for each type of raw material.

The volume measurement method using LiDAR according to an embodiment of the present disclosure includes: a data acquisition step of acquiring data of volume of volume measurement targets by means of a plurality of LiDAR sensors; and a volume calculation step of calculating the volume of the volume measurement targets by integrating the data acquired by the plurality of LiDAR sensors by means of a volume data integration calculator.

According to another embodiment of the present disclosure, the data acquisition step may include: controlling the plurality of LiDAR sensors by means of a LiDAR sensor controller; and acquiring the data measured by the plurality of LiDAR sensors by means of a data acquirer.

According to another embodiment of the present disclosure, the volume measurement method may further include: creating a three-dimensional point cloud by arranging the respective data measured by the plurality of LiDAR sensors based on a single reference point by means of a coordinate synchronizer after the acquiring of the data measured by the plurality of LiDAR sensors by means of a data acquirer.

According to another embodiment of the present disclosure, the volume measurement method may further include: after the creating of a three-dimensional point cloud, removing noise by optimizing the data of the three-dimensional point cloud by means of a noise filter; and setting an area that is an object for calculating the volume of the volume measurement targets in the three-dimensional point cloud by means of a target area setter.

According to another embodiment of the present disclosure, the volume measurement method may further include calculating the volume of the volume measurement targets using the three-dimensional point cloud with the set area by means of a volume calculator after the setting of an area that is an object.

According to another embodiment of the present disclosure, the volume measurement method may further include displaying the calculated volume of the volume measurement targets as a three-dimensional point cloud, with different colors assigned to respective three-dimensional areas by means of a volume information provider after the calculating of the volume of the volume measurement targets.

According to another embodiment of the present disclosure, the displaying of a three-dimensional point cloud may display the calculated volume of the volume measurement targets as a three-dimensional point cloud, with different colors according to the height of each three-dimensional area by means of the volume information provider.

According to another embodiment of the present disclosure, the displaying of a three-dimensional point cloud may collect the information on the calculated volume of the volume measurement targets, accumulate the information by type of raw material, and calculate and provide variation data and scale data for each type of raw material by means of the volume information provider.

### Effect of Invention

The volume measurement method and system using LiDAR according to the present disclosure can highly accurate volume measurement results in real time by measuring volume on the basis of data acquired from multiple LiDAR sensors, and can monitor in real time a storage space for raw materials, which are the volume measurement targets, through control of all operations such as operation control and data acquisition.

Further, according to the present disclosure, it is possible to use periodically acquired result data as a foundation for various fields, such as inventory management and asset operation.

### BRIEF DESCRIPTION OF THE DRAWING

FIG. 1 is a diagram illustrating a method of measuring the volume of raw materials using LiDAR according to the related art.

FIG. 2 is a configuration diagram of a volume measurement method using LiDAR according to an embodiment of the present disclosure.

FIG. 3 is a flowchart illustrating the volume measurement method using LiDAR according to an embodiment of the present disclosure.

FIG. 4 and FIG. 5 are diagrams illustrating, in more detail, the volume measurement method using LiDAR according to an embodiment of the present disclosure.

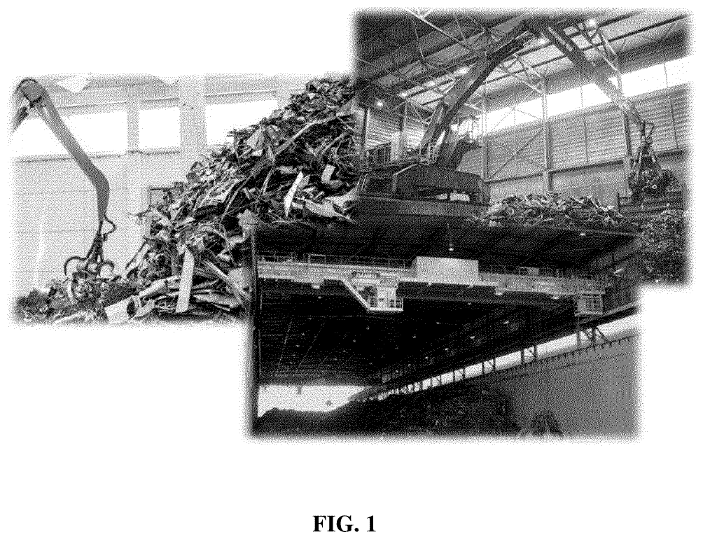

### BEST MODE FOR CARRYING OUT THE INVENTION

The present disclosure may be modified in various ways and implemented by various exemplary embodiments, so that specific exemplary embodiments are shown in the drawings and will be described in detail herein. However, it is to be understood that the present disclosure is not limited to the specific exemplary embodiments, but includes all modifications, equivalents, and substitutions included in the spirit and the scope of the present disclosure.

However, detailed descriptions of well-known functions or configurations relating to the present disclosure will not be provided so as not to unnecessarily obscure the description of the present disclosure. Further, the sizes of each component in the drawings may be exaggerated for the purpose of explanation and do not represent the actual sizes.

Further, throughout the specification, when a component is referred to as being “connected” or “coupled” to another component, it should be understood that the component may be directly connected or coupled to the other component. However, unless specifically stated otherwise, it may also be connected or coupled through an intermediary component. Further, throughout the present specification, unless explicitly described otherwise, ‘comprising’ any components will be understood to imply the inclusion of other components rather than the exclusion of any other components.

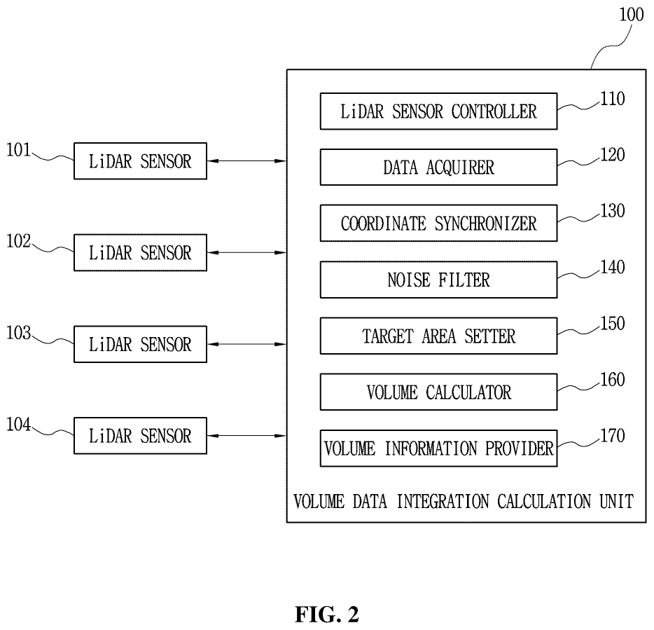

FIG. 2 is a configuration diagram of a volume measurement method using LiDAR according to an embodiment of the present disclosure.

Hereafter, the configuration of a volume measurement system using LiDAR according to an embodiment of the present disclosure is described.

A volume measurement system using LiDAR according to an embodiment of the present disclosure may be configured as a computer terminal, a server, or a dedicated device, or components providing respective functions may be configured as a computer terminal, a server, or a dedicated device, respectively. Alternatively, in a volume measurement system utilizing LiDAR according to another embodiment of the present disclosure, respective components providing respective functions may be configured as hardware or software.

In more detail, a volume measurement system using LiDAR according to an embodiment of the present disclosure includes a plurality of LiDAR sensors 101, 102, 103, and 104 and a volume data integration calculator 100.

The LiDAR sensors 101, 102, 103, and 104 may be disposed toward raw materials, which are volume measurement targets, to acquire data through measurement of the volume measurement targets.

The LiDAR sensors 101, 102, 103, and 104 installed in this way acquired data by measuring a volume measurement targets.

Accordingly, the volume data integration calculator 100 calculates the volume of the volume measurement targets by integrating the data acquired by the plurality of LiDAR sensors 101, 102, 103, and 104.

In more detail, the volume data integration calculator 100 may include a LiDAR sensor controller 110, a data acquirer 120, a coordinate synchronizer 130, a noise filter 140, a target area setter 150, a volume calculator 160, and a volume information provider 170.

The LiDAR sensor controller 110 controls the plurality of LiDAR sensors 101, 102, 103, and 104 and the data acquirer 120 acquires data measured by the plurality of LiDAR sensors.

Further, the coordinate synchronizer 130 creates a three-dimensional point cloud by arranging the respective data measured by the plurality of LiDAR sensors 101, 102, 103, and 104 based on a single reference point.

In this configuration, the noise filter 130 can remove noise by optimizing the data of the three-dimensional point cloud and the target area setter 150 can set an area that is the object for calculating the volume of the volume measurement targets in the three-dimensional point cloud.

Accordingly, the volume calculator 160 can calculate the volume of the volume measurement targets using the three-dimensional point cloud with the set area.

Further, the volume information provider 170 can display and provide the calculated volume of the volume measurement targets as a three-dimensional point cloud, with different colors assigned to respective three-dimensional areas.

In more detail, the volume information provider 170 can display the calculated volume of the volume measurement targets as a three-dimensional point cloud, with different colors according to the height of each three-dimensional area.

In addition, the volume information provider 170 can collect the information on the calculated volume of the volume measurement targets, accumulate it by type of raw material, and calculate and provide variation data and scale data for each type of raw material.

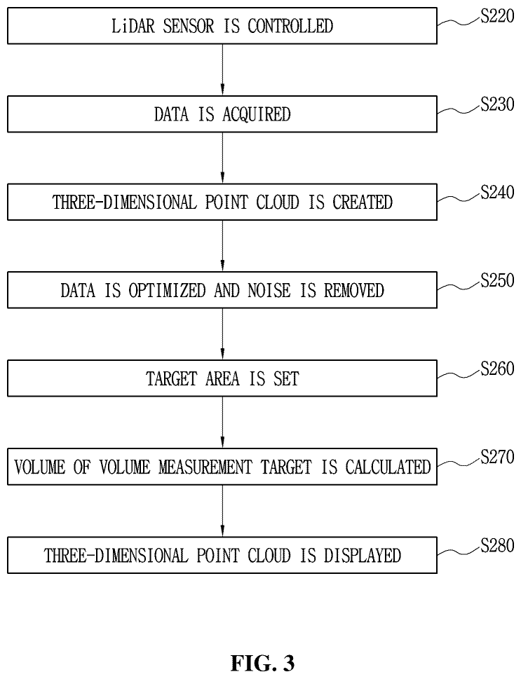

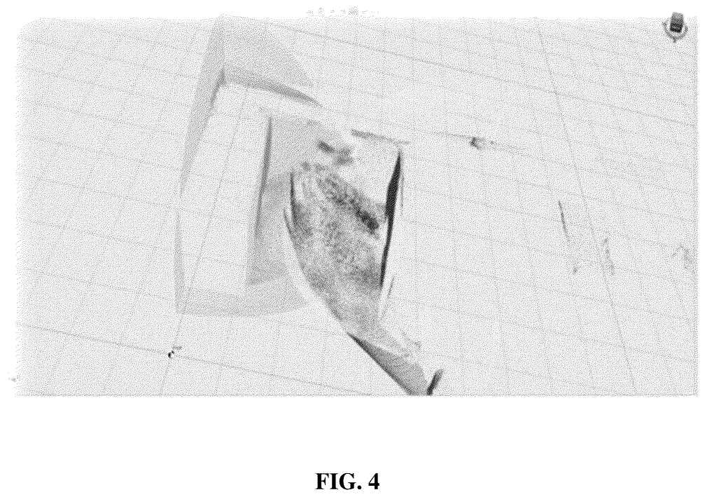

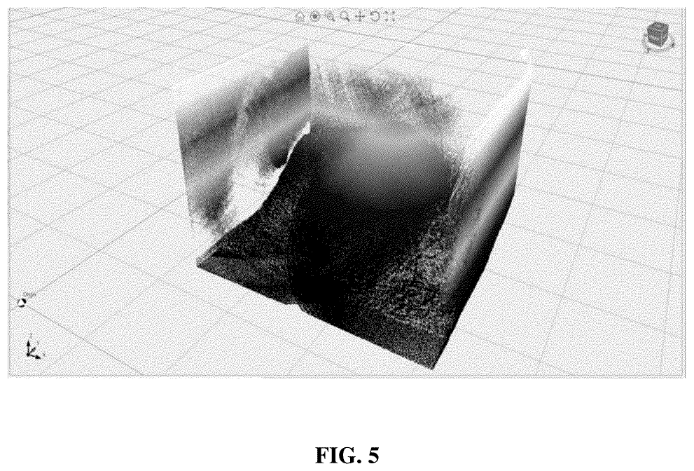

FIG. 3 is a flowchart illustrating the volume measurement method using LiDAR according to an embodiment of the present disclosure and FIG. 4 and FIG. 5 are diagrams illustrating, in more detail, the volume measurement method using LiDAR according to an embodiment of the present disclosure.

According to the volume measurement method using LiDAR according to an embodiment of the present disclosure, a plurality of LiDAR sensors acquires data of volume measurement targets and the volume data calculator calculates the volume of the volume measurement targets by integrating the data acquired by the plurality of LiDAR sensors.

Hereafter, the volume measurement method using LiDAR according to an embodiment of the present disclosure is described in more detail with reference to FIG. 3 to FIG. 5.

First, the LiDAR sensor controller controls a plurality of LiDAR sensors (S220) and the data acquirer acquires data measured by the plurality of LiDAR sensors (S230).

Thereafter, the coordinate synchronizer creates a three-dimensional point cloud by arranging the respective data measured by the plurality of LiDAR sensors based on a single reference point (S240).

Further, the noise filter removes noise by optimizing the data of the three-dimensional point cloud (S250) and the target area setter 150 sets an area that is the object for calculating the volume of the volume measurement targets in the three-dimensional point cloud (S260).

Thereafter, as shown in FIG. 4, the volume calculator calculates the volume of the volume measurement targets using the three-dimensional point cloud with the set area (S270).

Accordingly, the volume information provider displays and provides the calculated volume of the volume measurement targets as a three-dimensional point cloud, with different colors assigned to respective three-dimensional areas (S280).

In more detail, as shown in FIG. 5, the volume information provider can display the calculated volume of the volume measurement targets as a three-dimensional point cloud, with different colors according to the height of each three-dimensional area.

In addition, the volume information provider can collect the information on the calculated volume of the volume measurement targets, accumulate it by type of raw material, and calculate and provide variation data and scale data for each type of raw material.

Therefore, the volume measurement method and system using LiDAR according to the present disclosure can obtain highly accurate volume measurement results in real time by measuring volume on the basis of data acquired from multiple LiDAR sensors, and can monitor in real time a storage space for raw materials, which are the volume measurement targets, through control of all operations such as operation control and data acquisition.

Further, according to the present disclosure, it is possible to use periodically acquired result data as a foundation for various fields, such as inventory management and asset operation.

A detailed embodiment was described above in the detailed description. However, the present disclosure may be modified in various ways without departing from the scope of the present disclosure. The spirit of the present disclosure should not be limited to the above-described embodiment but should be defined by the claims and their equivalents.

### DESCRIPTION OF REFERENCE NUMERALS

101, 102, 103, 104: LiDAR sensor
100: volume data integration calculator
110: LiDAR sensor controller
120: data acquirer
130: coordinate synchronizer
140: noise filter
150: target area setter
160: volume calculator
170: volume information provider

What is claimed is:

1. A volume measurement system using LiDAR, comprising:
a plurality of LiDAR sensors configured to acquire data of volume measurement targets; and
a volume data integration calculator configured to calculate the volume of the volume measurement targets by integrating the data acquired by the plurality of LiDAR sensors.

2. The volume measurement system of claim 1, wherein the volume data integration calculator includes:
a LiDAR sensor controller configured to control the plurality of LiDAR sensors; and
a data acquirer configured to acquire the data measured by the plurality of LiDAR sensors.

3. The volume measurement system of claim 2, wherein the volume data integration calculation further includes a coordinate synchronizer configured to create a three-dimensional point cloud by arranging the respective data measured by the plurality of LiDAR sensors based on a single reference point.

4. The volume measurement system of claim 3, wherein the volume data integration calculator further includes:
a noise filter configured to remove noise by optimizing the data of the three-dimensional point cloud; and
a target area setter configured to set an area that is an object for calculating the volume of the volume measurement targets in the three-dimensional point cloud.

5. The volume measurement system of claim 4, wherein the volume data integration calculator further includes a volume calculator configured to calculate the volume of the volume measurement targets using the three-dimensional point cloud with the set area.

6. The volume measurement system of claim 5, wherein the volume data integration calculator further includes a volume information provider configured to display the calculated volume of the volume measurement targets as a three-dimensional point cloud, with different colors assigned to respective three-dimensional areas.

7. A volume measurement method using LiDAR, comprising:
a data acquisition step of acquiring data of volume of volume measurement targets by means of a plurality of LiDAR sensors; and
a volume calculation step of calculating the volume of the volume measurement targets by integrating the data acquired by the plurality of LiDAR sensors by means of a volume data integration calculator.

8. The volume measurement method of claim 7, wherein the data acquisition step includes:
controlling the plurality of LiDAR sensors by means of a LiDAR sensor controller; and
acquiring the data measured by the plurality of LiDAR sensors by means of a data acquirer.

9. The volume measurement method of claim 8, further comprising creating a three-dimensional point cloud by arranging the respective data measured by the plurality of LiDAR sensors based on a single reference point by means of a coordinate synchronizer after the acquiring of the data measured by the plurality of LiDAR sensors by means of a data acquirer.

10. The volume measurement method of claim 9, further comprising:
after the creating of a three-dimensional point cloud,
removing noise by optimizing the data of the three-dimensional point cloud by means of a noise filter; and
setting an area that is an object for calculating the volume of the volume measurement targets in the three-dimensional point cloud by means of a target area setter.

11. The volume measurement method of claim 10, further comprising calculating the volume of the volume measurement targets using the three-dimensional point cloud with the set area by means of a volume calculator after the setting of an area that is an object.

12. The volume measurement method of claim 11, further comprising displaying the calculated volume of the volume measurement targets as a three-dimensional point cloud, with different colors assigned to respective three-dimensional areas by means of a volume information provider after the calculating of the volume of the volume measurement targets.
